(19) United States
(12) Patent Application Publication
(10) Pub. No.: US 2024/0392657 A1
(43) Pub. Date: Nov. 28, 2024

(54) ENERGY HARVESTING AND RESOURCE CAPTURE FROM A WELL

(71) Applicant: SAUDI ARABIAN OIL COMPANY, Dhahran (SA)

(72) Inventors: Mustafa Alkhowaildi, Safwa (SA); Mohammed Abdullah Bataweel, Dhahran (SA); Eyad Ali Alali, Al-Ahsa (SA); Ahmed AlArnous, Udhailiyah (SA)

(73) Assignee: SAUDI ARABIAN OIL COMPANY, Dhahran (SA)

(21) Appl. No.: 18/324,822

(22) Filed: May 26, 2023

(51) Int. Cl. E21B 41/00; E21B 43/34

(52) U.S. Cl. CPC E21B 41/0085; E21B 41/005; E21B 43/34; G05B 15/02; G05B 2219/2639

(57) ABSTRACT

A system and method for generating and utilizing energy from a well flowback operation while separating and storing a commercial natural gas product is provided. The method includes connecting a portable unit comprising a multiphase turbine, an energy storage system, a multiphase conditioning unit and a plurality of storage units to a production tree during the well flowback operation and channeling a multiphase flow from the production tree to the portable unit. The method includes generating a created energy from channeling the multiphase flow from the production tree to the portable unit and utilizing the created energy by storing or directly consuming the created energy to power well operations. The method further includes separating the multiphase flow into a gas component and a nongaseous component, further conditioning the gas component into a commercial natural gas product and storing the commercial natural gas product in a plurality of storage units.

### BACKGROUND

In the petroleum industry, hydrocarbons are located in reservoirs far beneath the Earth's surface. Wells are drilled into these reservoirs to access and produce the hydrocarbons. Wells are structures that include casing strings, cement, and various production equipment. There are many different drilling methods in order to recover hydrocarbons most effectively. Some of these methods include injecting water, sand, and/or chemicals under a high pressure into a reservoir, called hydraulic fracturing to help aid in hydrocarbon access and extraction. Hydraulic fracturing is commonly performed in low-permeability rock formations and increases the oil and/or gas flow to a well from the hydrocarbon-bearing rock formations.

Once a well has been drilled, the formation fractured, and pipeline and production equipment is installed, a high pressured flowback operation may begin. Flowback operations are necessary for initial well cleanup, to remove fluids that were introduced to the well during hydraulic fracturing and any debris that accumulated in the wellbore. Flowback operations also assess the well's potential production and may last days to several weeks. The fluid produced during this flowback stage is a multiphase flow comprising a mixture of water, volatile hydrocarbons and hydraulic fracking fluids introduced by the well operations. This multiphase flow travels up the wellbore to a well head which may be connected to a production tree or Christmas tree on top of the wellhead. From here, the multiphase flow travels to be separated into gas and nongaseous components on a wellsite, and the gas may be vented or be burned in a process known as flaring. Flaring describes the process of burning the excess gas on a wellsite and emits a host of air pollutants. Similarly, when gas is vented, a high volume of methane and hydrocarbon emissions will be released into the atmosphere.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for generating and utilizing energy from a well flowback operation. The method includes connecting a portable unit comprising a multiphase turbine, an energy storage system, a multiphase conditioning unit and a plurality of storage units to a production tree during the well flowback operation and channeling a multiphase flow from the production tree to the portable unit. The method also includes generating a created energy from channeling the multiphase flow from the production tree to the portable unit and utilizing the created energy by storing or directly consuming the created energy to power well operations.

In general, in one aspect, embodiments relate to a method for separating and storing a commercial natural gas product. The method includes connecting the portable unit to a production tree during the well flowback operation and channeling a multiphase flow from the production tree to the portable unit. The method further includes separating the multiphase flow into a gas component and a nongaseous component by channeling the multiphase flow into a multiphase separation component inside a multiphase conditioning unit. The method also includes conditioning the gas component into the commercial natural gas product and storing the commercial natural gas product in a plurality of storage units.

In general, in one aspect, embodiments relate to a system that includes a production tree for a well flowback operation operatively connected to a portable unit. The portable unit of the system consists of a multiphase turbine having a multiphase inlet connected to a production tree during the well flowback operation, a generator component, an energy outlet to transfer a created energy, and a multiphase flow outlet to channel the multiphase component into the multiphase conditioning unit. The portable unit of the system also includes an energy storage system composed of a rechargeable battery set connected to an energy outlet of a multiphase turbine, a multiphase conditioning unit configured to process a gas component into a commercial natural gas product, and a plurality of storage units configured to house a commercial natural gas product.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a system in accordance with one or more embodiments.

FIG. 3 shows a flowchart in accordance with one or more embodiments.

FIG. 4 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments disclosed herein describe methods and systems for generating and utilizing energy from a well flowback operation. In accordance with one or more embodiments, the systems include a portable unit comprising a multiphase turbine, an energy storage system, a multiphase conditioning unit and a plurality of storage units. The portable unit is connected to a well during the flowback operation. The methods include generating a created energy by channeling the multiphase flow from a well's production tree to the portable unit and utilizing the created energy by storing the energy in an energy storage system, or by directly transferring the created energy to power well operations. The methods also include channeling the multiphase flow from a well's production tree to the portable unit, separating the gas and nongaseous components, further conditioning the gas component into a commercial natural gas product and store the gas for commercial use.

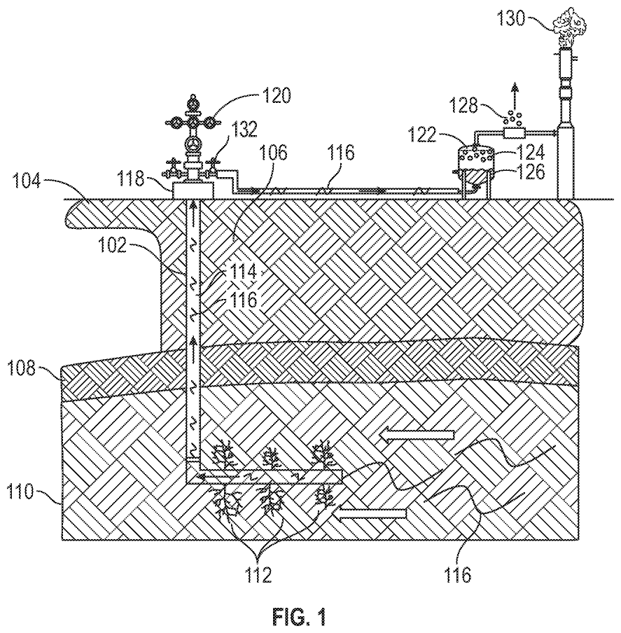

FIG. 1 illustrates a system in accordance with one or more embodiments. As shown in FIG. 1, a well (102) may be drilled into Earth's surface (104) and traverse a plurality of overburden layers (106) and one or more cap-rock layers (108) to a hydrocarbon reservoir (110). A hydrocarbon reservoir (110) may be hydraulic fractured during the drilling process, producing fractures (112) in the formation to encourage the flow of hydrocarbon material up through the wellbore (114) to

Earth's surface (104). During hydraulic fracturing, water, sand, and/or chemicals may be injected into the hydrocarbon reservoir (110). Once the formation has been fracked and the production equipment has been installed, the well (102) is opened and a flowback phase may begin. Flowback is the first volatile stage of a well's production and is necessary for initial well cleanup, to remove the fluids that were introduced into the well (102) during hydraulic fracking and any debris that may have accumulated in the wellbore (114).

During a flowback operation, a multiphase flow (116) comprising a mixture of cleanup materials from hydraulic fracturing, reservoir gas and liquids, water and sand travels up the wellbore (114) to a well head (118) which may be connected to a production tree (120) or Christmas tree. A production tree (120) is a vertical assembly of valves with gauges and chokes that allow for flow control during a flowback operation. The multiphase flow (116) travels through the main flowback outlet (132) and is sent along a network of pipelines to at least one separation unit (122), where the solid, liquid, and gas components of the multiphase flow (116) may be separated. In some embodiments, the multiphase flow (116) may first be directed to a sand separator (not shown) in order to separate the sand, clay and other naturally occurring solids from the remainder of the multiphase flow (116). The flowback gas (124) and liquid (126) may then be separated further inside of a separation unit (122). The separated flowback solid and liquids (126) may be stored at the wellsite and disposed of and the flowback gas (124) may be passed further along the network of pipelines to be vented (128) or flared (130).

The process of venting (128) includes the direct release of the flowback gas (124) into the atmosphere. Venting (128) may be performed to divert and dispose of the flowback gas (124) prior to a wells production and to avoid a pressure buildup inside the well (102). The flowback gas (124) may include several types of natural gases including methane, ethane, butane and various hydrocarbon emissions that have a negative environmental impact. Flaring (130) describes the controlled combustion of the flowback gas (124) as a means of disposal. Flaring (130) may also be performed as a safe combustion of volatile organic compounds, such as hydrogen sulfide. Both venting (128) and flaring (130) are performed to divert and dispose of the flowback gas (124) away from the well (102) and may release a host of pollutants into the atmosphere. In some embodiments, a portion of the flowback gas (124) may be further conditioned, separated, and collected as a commercial natural gas product, however it is often not economical to do so in remote wellsite locations.

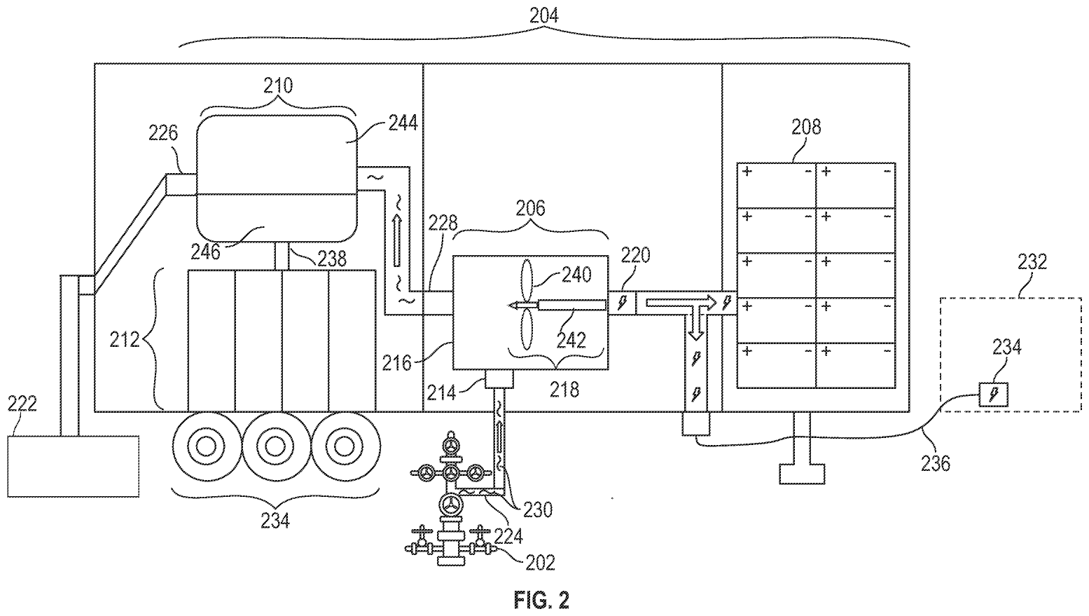

FIG. 2 describes a system for generating and utilizing energy and separating and storing a commercial natural gas product from a well flowback operation, in accordance with one or more embodiments. The system includes a production tree (202) having a main flowback outlet (224) connected to the multiphase turbine inlet (214) of a portable unit (204) during a well's flowback operations. A portable unit (204) describes a multifunctioning mobile tool that is capable of reaching remote wellsite areas to harvest energy from a well's flowback operations.

The portable unit (204) comprises a multiphase turbine (206), an energy storage system (208), a multiphase conditioning unit (210), and a plurality of storage units (212) for housing a commercial natural gas product. The portable unit (204) may include any number of wheels (234) that allow for transportation to a remote well site. The portable unit (204) may be towed or transported by any other means to reach the wellsite destination. The portable unit (204) should be placed in a location in close approximation to the main flowback outlet (224) of the production tree (202).

Once the well is opened by opening a flow valve (not shown) on the production tree and the flowback operations begin, the multiphase flow (230) will travel up the well to the production tree (202). The production tree (202) includes an assembly of valves, casing spools, fittings, and a main flowback outlet (224) used to regulate a multiphase flow (230) coming from the well flowback operation. A flow valve included on the production tree may be opened to initiate the multiphase flow (230) out of the main flowback outlet (224). The main flowback outlet (224) describes the outlet on the production tree that directs the multiphase flow (230) away from the well. In FIG. 1, traditional methods of disposal of this multiphase flow (230) are shown including venting (128) and flaring (130) which release a host of pollutants into the atmosphere. In this disclosure, the addition of the portable unit (204) is introduced into the system to generate and utilize energy from this multiphase flow (230). Additionally, the portable unit also enables the separation of the multiphase flow into a gas and nongaseous component and storing of a commercial natural gas product.

The main flowback outlet (224) may be connected to the multiphase turbine inlet (214) to direct the multiphase flow (230) into the multiphase turbine (206) in order to harvest the energy of the high-pressure multiphase flow (230). In some embodiments, the multiphase turbine inlet (214) may comprise a suction inlet or any other intake port. The multiphase turbine (206) in FIG. 2 is illustrated as a black box and a variety of multiphase turbines (206) with different mechanisms and components may be used to fit the invention. In some embodiments, the multiphase turbine (206) included in the portable unit (204) may be a two-phase or three-phase rotary separator turbine. A rotary separator turbine describes a machine that produces power from the expansion of a multiphase fluid such as the multiphase flow (230) and may discharge separate outlets of liquids, solids, and gas. In some embodiments, when a two-phase rotary separator turbine is used in the portable unit (204), the main flowback outlet (224) may be connected to one or more sand separators (not shown) before connecting the multiphase flow line to the multiphase turbine inlet (214). Sand separators will separate the solid material out of the multiphase flow (230) and enable the use of a two-phase rotary separator turbine to generate power and separate the liquid and gas components further.

The multiphase turbine (206) includes a generator component (218), an energy outlet (220) to transfer a created energy and a multiphase outlet (228) to channel the multiphase flow (230) into the multiphase conditioning unit (210). The generator component (218) receives the multiphase flow directly from the multiphase turbine inlet (214) and generates a created energy.

A created energy is generated in the generator component (218) of the multiphase turbine (206) and my travel to the energy outlet (220) where the energy can be transferred to the energy storage system (208) or transferred to power the well operations, demonstrated by box (232). Any method used by a variety of multiphase turbines may be used to create the energy in the generator component (218). In the generator component (218) of the multiphase turbine (206), the flowing multiphase flow (230) may push a series of blades (240) mounted on a rotor shaft (242). The force of the multiphase flow (230) rotates the rotor shaft (242) inside the generator component (230) and the generator component (230) converts the mechanical energy of the rotor to an electrical energy . . .

This created electrical energy may be utilized by storing the created energy on the energy storage system (208) or directly consuming the created energy to power well operations (232), illustrated by the black box. In accordance with one or more embodiments, an energy storage system (208) comprises a rechargeable battery set connected to an energy outlet (220) of the multiphase turbine (206). The rechargeable battery set may be rotated in and out of the energy storage system (208) and used on the wellsite. Rechargeable battery sets may be utilized on a wellsite for powering a number of different operations including wireline operations, well interventions, cleanouts, and powering normal facility operations for wellsite personnel. The electricity generated from the multiphase turbine (206) may also be directed to supply power to the well operations (232). Wellsites often utilize electric generators to provide power to numerous well operations (232). These electric generators provide power to various wellsite equipment including various engines, pumps and wellsite lighting. In some embodiments, powering well operations (232) may be the primary focus of harvesting the created electric energy with a secondary focus of storing any excess created energy for later use. In these embodiments to power well operations (232), the energy outlet (220) of the multiphase turbine (206) is connected to an external circuit (234) of the well operations (232) with a power cable (236). In some embodiments, an external circuit (234) may be an electric generator, capable of delivering power to other well operations (232). In some embodiments, once the well operations (232) no longer require a power source, the electricity generated from the multiphase turbine (206) may be directed to the energy storage system (208) to harvest the excess supply of created electrical energy. Once the generator component (218) has been stimulated by the multiphase flow (230) to create energy, the multiphase flow (230) is now passed to a multiphase conditioning unit (210) to process the multiphase flow (230) into a gas component and a nongaseous component and further process the gas component to create a commercial natural gas product to be stored. The multiphase conditioning unit includes a multiphase separation component (244) for separating the multiphase flow (230) into a gas and nongaseous component. The multiphase separation component (244) may include a separator drum (not shown) that rotates at a high speed when stimulated by the multiphase flow (230). The resulting centrifugal force inside the rotating separator drum, will cause a separation of the gas component and the nongaseous components In some embodiments the multiphase conditioning unit (210) may also include a waste outlet (226) for the nongaseous material. In some embodiments, the waste outlet (226) may be connected to the multiphase conditioning unit (210) and in other embodiments the waste outlet (226) may be connected to the multiphase turbine (206) dependent on the multiphase turbine (206) design. The waste outlet (226) may be connected to at least one disposal container (222) to store the nongaseous materials. In some embodiments, there may be a separate disposal container (222) for each of the solid and liquid components of the multiphase flow (230).

The gaseous component is then channeled to an impurity filter (246). The impurity filter (246) removes a gas impurity from the gas component, to create a commercial natural gas product. To this end, impurities removed from the gas component may include brine water, formation sands, organic content, or other oil and gas chemicals such as: scale inhibitors/stabilizers, etc.

A plurality of storage units (212) are connected to a gas outlet (238) of the multiphase conditioning unit (210) to store the commercial natural gas products. In some embodiments, the natural gas products may be a mixture of two or more hydrocarbon gases produced from the well with impurities removed. In some embodiments, the commercial natural gas products, to be transported and sold commercially.

FIG. 1 has described standard flowback operations including venting and flaring. The portable unit (204) described in FIG. 2 may be introduced into the flowback operation in order to harvest energy from the multiphase flow that otherwise go wasted. In addition, the portable unit (204) is capable of separating and storing a commercial natural gas product, which is often nonviable to do so in remote wellsite locations. Furthermore, by capturing and storing the natural gas products, the addition of the portable unit (204) helps to minimize releasing harmful pollutants in the air, which is a significant negative consequence when venting and flaring.

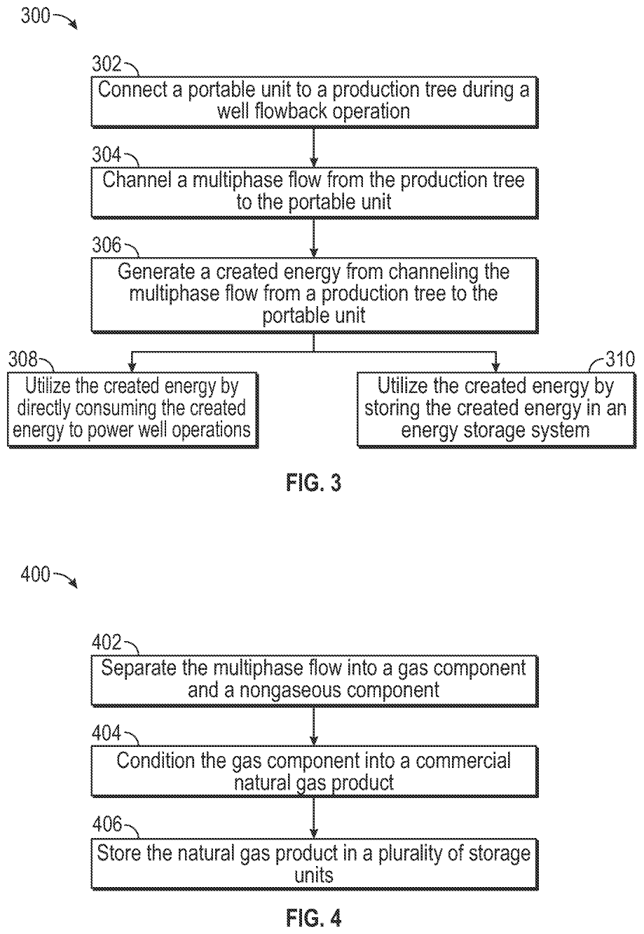

FIG. 3 shows a flowchart in accordance with one or more embodiments. The flowchart outlines a method for generating a created energy by channeling the multiphase flow from a well's production tree to a portable unit and utilizing the created energy by storing the energy in an energy storage system or by directly consuming the created energy to power well operations. A multiphase flow comprising a mixture of cleanup materials and reservoir gas and liquids which exits the well during a well flowback operation is typically collected, separated and disposed of. The method disclosed herein, describes utilizing this multiphase flow to be able to create and utilize a created energy.

In Step 302 in accordance with one or more embodiments, a portable unit is connected to a production tree during a well flowback operation. The portable unit includes a multiphase turbine, an energy storage system, a multiphase conditioning unit, and a plurality of storage units. A production tree may include a main flowback outlet used to regulate a multiphase flow coming from the well flowback operation and direct the multiphase flow away from the well. The main flowback outlet may be connected to a multiphase turbine inlet included on the multiphase turbine.

In Step 304 in accordance with one or more embodiments, a multiphase flow is channeled from the production tree to the portable unit. The multiphase flow is initiated by opening the flow valve on the production tree allowing for free movement of the multiphase flow into the portable unit. The multiphase flow enters a multiphase turbine at the multiphase turbine inlet to initiate the energy harvesting process. The multiphase turbine further includes a generator component, an energy outlet to transfer a created energy gas and a multiphase outlet to channel the multiphase flow into the multiphase conditioning unit. In some embodiments, the multiphase turbine may be a two or three-phase rotary separator turbine. Any turbine capable of generating energy from a multiphase flow may be included as a part of the portable unit without deviating from the scope of the method.

In Step 306 in accordance with one or more embodiments, a created energy is generated from channeling the multiphase flow from the production tree to the portable unit. Specifically, the energy is created in the generator component of the multiphase turbine. While the multiphase flow enters the generator component of the multiphase turbine the flowing multiphase flow may push a series of blades mounted on a rotor shaft and converts the mechanical energy of the rotor to an electrical energy.

In Step 308 in accordance with one or more embodiments, the created energy is utilized by directly consuming the created energy to power well operations. A power cable may be used to connect the energy outlet of the multiphase turbine to an external circuit that is responsible for providing power to well operations. In some embodiments, the portable unit may be designed as to prioritize the created energy to power well operations. Powering well operations from a multiphase flow may be particularly beneficial on a remote wellsite with limited options for supplied power.

In Step 310 in accordance with one or more embodiments, the created energy is utilized by storing the created energy in an energy storage system. The energy storage system comprises of a rechargeable battery set that can be utilized on the wellsite. The energy storage system is connected to an energy outlet of the multiphase turbine. The rechargeable battery set may be rotated in and out of the energy storage system and used on the wellsite. In some embodiments, utilizing the created energy by storing the created energy in an energy storage system may be a secondary focus of the portable unit. In some embodiments, only a portion of the created energy is directed to the energy storage system, while the majority is directed to power well operations.

FIG. 4 shows a flowchart in accordance with one or more embodiments. The flowchart outlines a secondary method utilized by the portable unit for separating the multiphase flow into a commercial natural gas product to be stored for commercial use. In Step 402, in accordance with one or more embodiments, the multiphase flow is separated into a gas component and a nongaseous component. In some embodiments, the multiphase flow may be separated completely within the multiphase turbine and in other embodiments the separation of the multiphase flow occurs in the multiphase conditioning unit. Once the nongaseous material from the multiphase flow is separated from the remainder of the gas component, it is directed to a waste outlet where it may be stored in at least one disposal container.

In Step 404, in accordance with one or more embodiments, the gas component is conditioned into a commercial natural gas product. Once the gas component has been separated from the nongaseous components of the multiphase flow, the gas component is directed to an impurity filter. The impurity filter removes a gas impurity from the gas component and generates the commercial natural gas product. Such gas impurities may include brine water, formation sands, organic content, or other oil and gas chemicals such as: scale inhibitors/stabilizers, etc.

In Step 406, and in accordance with one or more embodiments, the natural gas product is stored in at least one of a plurality of storage units. The plurality of storage units are connected to a gas outlet of the multiphase conditioning unit. The processed commercial natural gas is directed from the impurity filter into the plurality of storage units through the gas outlet. In some embodiments there may be separate storage units for different forms of natural gas. The natural gas products may then be sold or repurposed for well operations.

The methods disclosed herein provide the advantage of utilizing the multiphase flow from a well flowback operation, which typically goes unused. Energy is created from the multiphase flow by channeling the flow through a portable until where energy is created and stored or consumed, and the multiphase flow is further separated and conditioned to for storage of a natural gas product, without the use of venting or flaring which emits pollutants into the atmosphere. The additional power generation is particularly beneficial on a remote wellsite with limited access to power.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A method for generating and utilizing energy from a well flowback operation, the method comprising:
connecting a portable unit to a production tree during the well flowback operation;
channeling a multiphase flow from the production tree to the portable unit;
generating, a created energy from channeling the multiphase flow from the production tree to the portable unit; and
utilizing, the created energy by storing the created energy or directly consuming the created energy to power well operations.

2. The method of claim 1, wherein the portable unit comprises a multiphase turbine, an energy storage system, a multiphase conditioning unit and a plurality of storage units.

3. The method of claim 2, wherein the multiphase turbine comprises a multiphase turbine inlet connected to a production tree during the well flowback operation, a generator component, an energy outlet to transfer a created energy, and a multiphase outlet to channel the multiphase phase into the multiphase conditioning unit.

4. The method of claim 1, wherein utilizing, the created energy by storing the created energy comprises connecting an energy outlet of a multiphase turbine, to an energy storage system.

5. The method of claim 4, wherein the energy storage system comprises a rechargeable battery set.

6. The method of claim 1, wherein directly consuming the created energy to power well operations comprises connecting an energy outlet of a multiphase turbine to an external circuit with a power cable.

7. A method for separating and storing a commercial natural gas product from a well flowback operation, the method comprising:
connecting a portable unit to a production tree during the well flowback operation;
channeling a multiphase flow from the production tree to the portable unit;
separating the multiphase flow into a gas component and a nongaseous component;
conditioning the gas component into the commercial natural gas product; and
storing the commercial natural gas product in a plurality of storage units.

8. The method of claim 7, wherein the portable unit comprises a multiphase turbine, an energy storage system, a multiphase conditioning unit and the plurality of storage units.

9. The method of claim 8, wherein the multiphase turbine comprises a multiphase turbine inlet connected to a production tree during the well flowback operation, a generator component, an energy outlet to transfer a created energy and a multiphase outlet to channel a multiphase flow into the multiphase conditioning unit.

10. The method of claim 7, wherein separating the multiphase flow into the gas component and the nongaseous component further comprises channeling the multiphase flow into a multiphase separation component inside a multiphase conditioning unit.

11. The method of claim 10, wherein the multiphase separation component directs the nongaseous component to a waste outlet to dispose of the nongaseous component in a disposal container.

12. The method of claim 7, wherein conditioning the gas component into the commercial natural gas product comprises channeling the gas component to an impurity filter to remove a gas impurity from the gas component.

13. The method of claim 12, wherein storing the commercial natural gas product in the plurality of storage units comprises channeling the gas component from the impurity filter to a gas outlet connected to the plurality of storage units.

14. A system for generating and utilizing energy and separating and storing a commercial natural gas product from a well flowback operation, the system comprising:
a production tree for the well flowback operation;
a portable unit operatively connected to the production tree during the well flowback operation, the portable unit comprising:
a multiphase turbine;
an energy storage system;
a multiphase conditioning unit; and
a plurality of storage units, wherein the plurality of storage units are configured to house the commercial natural gas product;
wherein the portable unit is a multifunctioning mobile tool configured to reach a remote wellsite.

15. The system of claim 14, wherein the production tree comprises of an assembly of valves, casing spools, fittings, and a main flowback outlet used to regulate a multiphase flow coming from the well flowback operation.

16. The system of claim 14, wherein the multiphase turbine comprises a multiphase turbine inlet connected to a production tree during the well flowback operation, a generator component, an energy outlet to transfer a created energy and a multiphase outlet to channel a multiphase flow into the multiphase conditioning unit.

17. The system of claim 16, wherein the energy outlet is configured to transfer the created energy to be stored on the energy storage system.

18. The system of claim 17, wherein the energy storage system comprises a rechargeable battery set configured to be rotated in and out of the energy storage system for use at a location on a wellsite different from a location of the portable unit.

19. The system of claim 17, wherein the energy outlet is further configured to transfer the created energy to an external circuit to power well operations using a power cable.

20. The system of claim 14, wherein the multiphase conditioning unit comprises:
a multiphase separation component configured to separate a multiphase flow into a gaseous component and a nongaseous component;
a waste outlet configured to channel the nongaseous component into a disposal container;
an impurity filter configured to receive the gaseous component and remove any of a gas impurity from the gaseous component to produce a natural gas product; and
a gas outlet configured to channel the commercial natural gas product to the plurality of storage units.
